(19) United States
(12) Patent Application Publication
(10) Pub. No.: US 2021/0330523 A1
(43) Pub. Date: Oct. 28, 2021

(54) Adjustable Extremity Suspension Apparatus

(71) Applicant: Daniel Sikora, Cedar Crest, NM (US)

(72) Inventor: Daniel Sikora, Cedar Crest, NM (US)

(21) Appl. No.: 16/858,614

(22) Filed: Apr. 25, 2020

(51) Int. Cl. A61G 5/12; A47C 16/00; A47B 83/04; A47C 20/02; A47C 27/08

(52) U.S. Cl. CPC A61G 5/125; A47C 16/00; A47C 27/085; A47C 20/02; A47C 27/081; A47B 83/04

(57) ABSTRACT

An Adjustable Extremity Suspension Apparatus for supporting patient limbs, the apparatus ambidextrous and adaptable to be mounted on various appliances in proximity a patient and configurable to accommodate specialized support and position needs. The Adjustable Extremity Suspension Apparatus comprising a longitudinally elongated tray-type frame that creates an elongated channel into which a longitudinally elongated elastic sheet drapes in order to form a flexible, saddle-like structure. Selectable materials, attachments and mounting provide user-configurable extremity support and ease o use.

### TECHNICAL FIELD OF THE INVENTION

This application pertains to an apparatus providing adjustable support to patients experiencing paralysis/paresis/hypertonicity in their extremities as well as providing increased comfort to any rehabilitation or wheelchair bound patients recovering from stroke, surgery or injury.

### BACKGROUND OF THE INVENTION

Loss of muscle control, whether due to stroke, injury or any other disease, imposes significant challenge to the physical therapist during rehabilitation process and also to the day-today routine care takers of patients. Patients experiencing such a condition can be difficult to work with at a minimum and may even exhibit enough postural instability to be a danger to themselves or others, thus requiring additional help or the use of overly restrictive devices. These restrictive devices can cause further legal and mental challenges during process of rehabilitation impeding recovery, which can cause other problems or delay recovery. While there are many causes of loss of muscle control, two common condition that result from a stroke are spastic paralysis and flaccid paralysis.

Spasticity is a muscle control disorder that is characterized by tight or stiff muscles and an inability to control those muscles. In addition, reflexes may persist for too long and may be too strong (hyperactive reflexes), It is often found in people with stroke, cerebral palsy, traumatic brain injury, multiple sclerosis, and spinal cord injury, Some of the symptoms include overactive reflexes, involuntary movements, which may include spasms (brisk and/or sustained involuntary muscle contraction) and cionus (series of fast involuntary contractions). Occupational and physical therapy programs, involving muscle stretching and range of motion exercises, and sometimes the use of braces, may help prevent tendon shortening. The pain associated with spasticity can be as mild as a feeling of tight muscles, or it can be severe enough to produce painful spasms of the extremities, including the legs. In these patients, it is difficult to control their extremities, including keeping their arms and legs on available rests, supports, etc. This can lead to loss of balance and possibly injurious falls.

Flaccid paralysis is a neurological condition characterized by weakness or paralysis and reduced muscle tone without other obvious cause (e.g., trauma). This abnormal condition may be caused by disease or by trauma affecting the spinal cord or nerves associated with the involved muscles. For example, if the somatic nerves to a skeletal muscle are severed, then the muscle will exhibit flaccid paralysis. When muscles enter this state, they become limp and cannot contract. In this condition, a patient is unable to control their extremities, including keeping their arms and legs on available rests, supports, etc. This can lead to loss of balance and possibly injurious falls.

Complicating the treatment and recovery process is the lack of support adjustability and other comfort features in currently available rests, supports, etc. for patient extremities. Slings and padded arm rests have fixed contours and are either overly restrictive or possess no secure containment characteristics at all. It is often desired to provide customizable dynamic support and a secure restrictive zone of movement, or at least and also to provide uniform support along an extremity. This is not achieved in the existing art. This can leave the patient uncomfortable at the least, or in a precarious position if ignored.

Finally, patient irritability and infections due to moisture buildup or lack of oxygen exposure to the extremity arising from sling-type and similar support devices may require additional medical attention and modified care routines, thus complicating and possibly delaying the recovery period.

It is therefore an objective of the instant invention to provide an apparatus that provides breathable, adjustable containment and weight dissipation along the length of a patients extremities.

It is a further objective of the instant invention to provide an apparatus that promotes blood flow through the elevation of the limb reducing edema in the limb.

It is a further objective of the instant invention to provide an apparatus that flexibly and ambidextrously mounts to a range of appliances in use by a patient including wheelchairs, chairs, tables, stands, baths, beds and others.

It is a further objective of the instant invention to provide an apparatus that provide dynamic tension to spastic extremities of patient.

It is a further objective of the instant invention to provide support to unstable posture and improve comfort of patient by having vertically and horizontally adjustable support to upper extremity.

### SUMMARY OF THE INVENTION

In one embodiment, the current invention comprises an elongated frame having a channel within which an elastic sheet is suspended, thus creating an adjustable containment sling for customized patient extremity support.

In an alternate embodiment, the current invention may comprise an adjustable angle elongated frame within which an elastic sheet is suspended, thus creating an adjustable tension containment sling for further customized patient extremity support for joints, for example.

In an alternate embodiment, the current invention may comprise multilayered elastic sheet construction to achieve customized support, containment, breathability, moisture control, blood flow support and other desired characteristics.

In an alternate embodiment, the current invention may comprise a mounting provision providing elevation, angle and universal position adjustments for use with wheelchairs, chairs, tables, stands, baths, beds and other patient implements.

### BRIEF DESCRIPTION OF THE DRAWINGS

FIG. 1 illustrates the elongated frame of the invention.

FIG. 2 illustrates the elastic sheet of the invention.

FIG. 3 illustrates a cross-sectional end view of the invention including the elongated frame and the elastic sheet covering.

FIG. 4 illustrates a side view of the invention.

FIG. 5 illustrates an alternate embodiment of the frame of the invention.

FIG. 6 illustrates the layer detail of the elastic sheet of the invention. .

FIG. 7 illustrates example mounting provisions on the bottom of the elongated frame.

FIG. 8 illustrates the invention as mounted on a wheelchair.

FIG. 9 illustrates the invention as mounted on a wheelchair and positioned to accommodate a user.

FIG. 10 illustrates an embodiment of mounting hardware.

### DETAILED DESCRIPTION OF THE INVENTION

The accompanying drawings illustrate example embodiments of the invention and its concepts. The drawings are not to scale. The terms and language used herein is for the purpose of describing particular aspects of the invention and are not intended to be limiting of the invention.

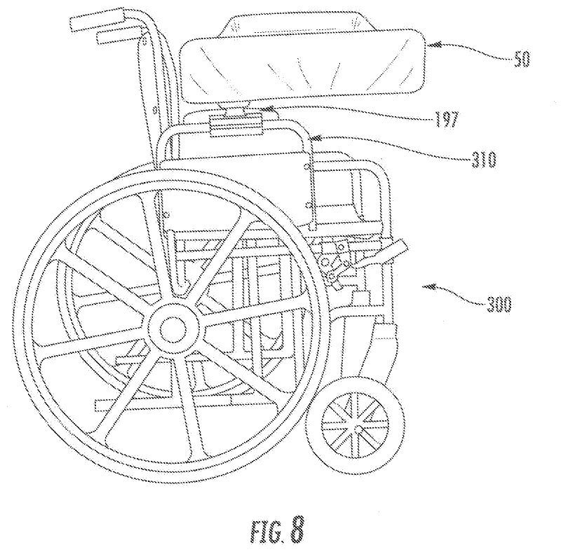

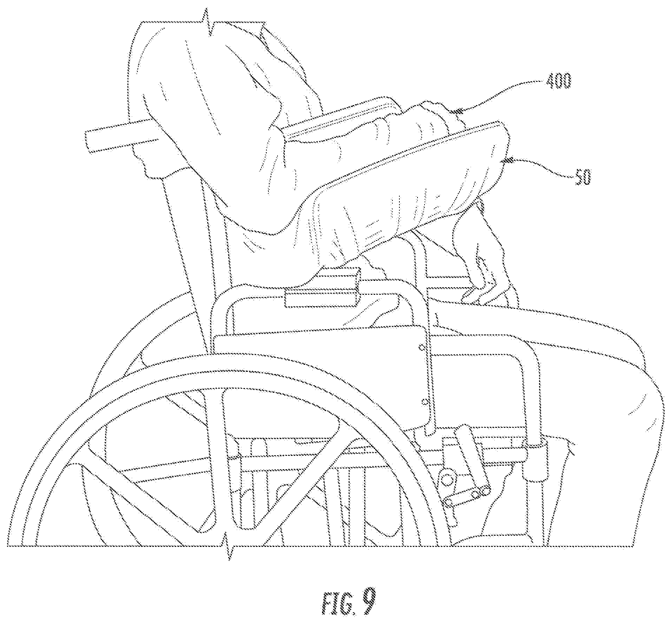

For overall demonstration, FIG. 4 depicts the preferred physical embodiment of the Adjustable Extremity Suspension Apparatus (50). FIG. 8 depicts attachment of the Adjustable Extremity Suspension Apparatus (50) to a wheelchair 300 and FIG. 9 shows a patient using a wheelchair (300) mounted Adjustable Extremity Suspension Apparatus (50) to suspend an extremity, in this case, the forearm (400).

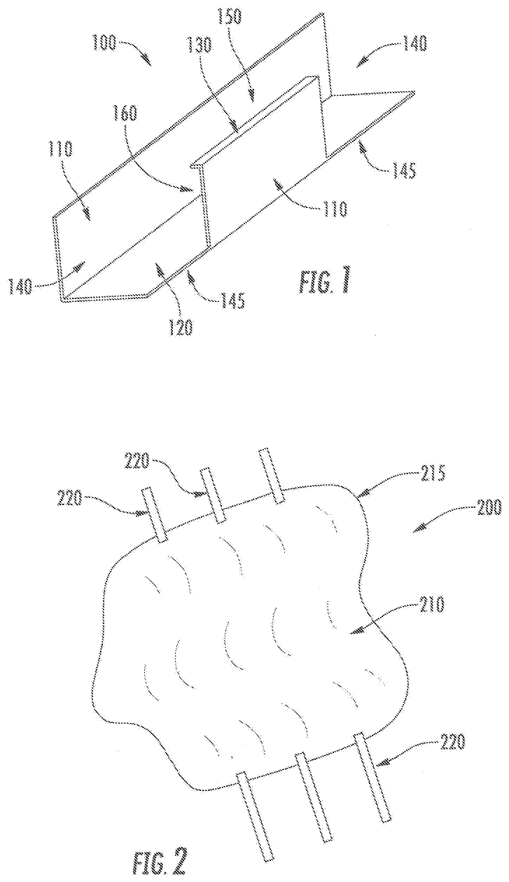

Referring to FIGS. 1, 2 and 3, the Adjustable Extremity Suspension Apparatus (50) may be comprised of a longitudinally elongated frame (100) and an elastic sheet (200). The longitudinally elongated frame (100) is comprised of two longitudinally elongated vertical opposing sides (110), two opposing open ends (140), an open top (150), and a bottom (120). The two longitudinally elongated vertical opposing sides (110) extend up from the bottom (120) thus creating an elongated channel (160) between the two longitudinally elongated vertical opposing sides (110) and further creating an exterior surface (170) along, the longitudinally elongated frame (100) outside or opposite of the channel (160) on the inside.

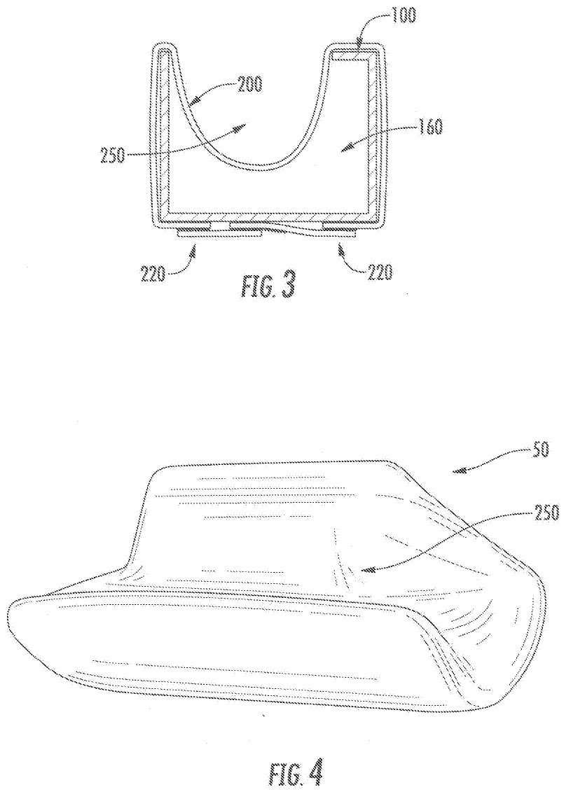

While FIGS. 1 and 3, and later FIGS. 5, 7 and 10, exemplify a straight rectangular shape of the longitudinally elongated frame (100), it would be clear to one of ordinary skill in the art that the two longitudinally elongated vertical opposing sides (110) that extend up from the bottom (120) do not necessarily have to extend up at a 90 degree angles, nor are they necessarily planar in structure. Each may be independently contoured in shape and size and may extend up from the bottom (120) in other than 90-degree angles in order to accommodate a desired shape of the elongated channel (160). Thus, for the instant invention, the term vertical opposing sides is meant to include non-planar sides that extend up from the bottom (120) in 90-degree angles as well as non-planar sides that extend up from the bottom (120) in other than 90-degree angles. Similarly, the bottom (120) may be other than a planar rectangular shape.

The longitudinally elongated frame (100) may be constructed of any rigid material which holds its shape while supporting the weight of a patient's extremity, such as a forearm (400), under ambient conditions, including most metals, including stainless steel, and plastics and even recycled materials. In the preferred embodiment, the longitudinally elongated frame (100) is made of lightweight molded plastic, which is easily and inexpensively formed and does not invite bacterial colonization.

The elongated elastic sheet (200) is a flexible elastic material, and has a perimeter (215) sufficiently sized and shaped to drape over the open top (150) of the longitudinally elongated frame (100) and around and adjacent to the exterior surface (170) of the longitudinally elongated frame (100). In alternate embodiments, the elongated elastic sheet (200) may be fabricated or pre-formed such that it forms an elongated cavity (250) within the elongated channel (160) when draped over the longitudinally elongated frame (100). This structural feature will not always be necessary due to the elasticity of materials that may be used for the elongated elastic sheet (200). Positioned along the perimeter (215) of the elastic sheet (200) are paired adjustable length attachment mechanisms (220) that attach to secure the elongated elastic sheet (200) around the longitudinally elongated frame (100).

The paired adjustable length attachment mechanisms (220) may be of a belt-type construction with cam, ratchet, D-ring, side release, bar slide, or any similar-type buckles that secure tension on the belt. While belt latch-type buckles work, it is preferred to have an arrangement that accommodates continuous latching capability as opposed to discrete, periodic adjustments. Furthermore, each adjustable length attachment mechanism pair (220) may be adjusted individually, thus allowing for a customized support along the length of the patient's extremity. In the preferred embodiment, the paired adjustable length attachment mechanisms (220) are hook and loop type mechanisms.

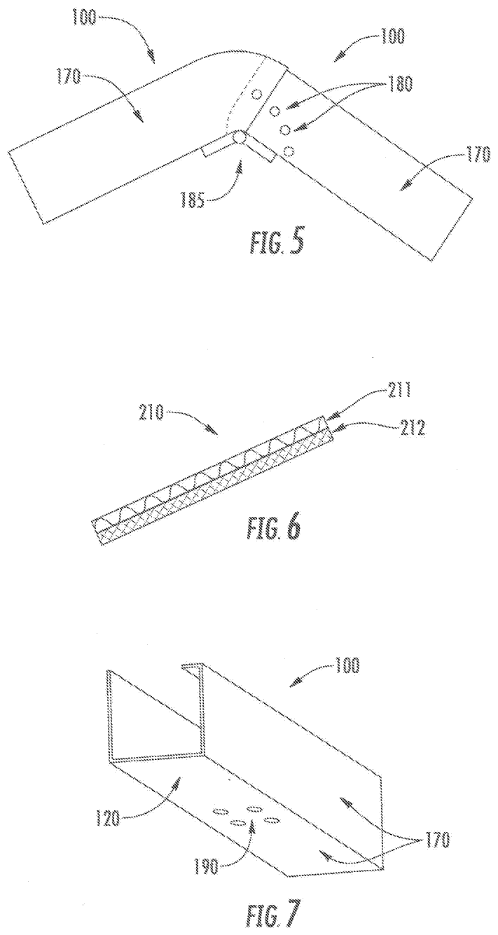

Referring to FIG. 6, the flexible elastic material (210) of the elongated elastic sheet (200) may be of a single layer or multi-layered. In the preferred embodiment, the elongated elastic sheet (200) is constructed of an upper layer (211) of a breathable polyester material and a lower layer (212) of mesh. In alternate embodiments, the breathable polyester material and/or the mesh are fabricated or coated to exhibit hydrophilic properties for wicking moisture away from the patient. The lower layer (212) also exhibits elastic properties, such that together, the upper (211) and lower (212) layers making up the elongated elastic sheet (200), resistively stretch when draped over the longitudinally elongated frame (100) to create an extremity receptacle (250) within the elongated channel (160) of the longitudinally elongated frame (100) for properly supporting the patient's extremity. Various materials may be chosen for the construction of the elongated elastic sheet (200) regardless of the number of layers used.

In an alternate embodiment, the perimeter (215) of the elastic sheet (200) comprises an elastic band or draw string to help keep the elongated elastic sheet (200) secured over the longitudinally elongated frame (100).

Referring to FIG. 7, the longitudinally elongated frame (100) of the Adjustable Extremity Suspension Apparatus (50) may be configured to accept a mounting mechanism for securing the Adjustable Extremity Suspension Apparatus (50) to a wheelchair (300), stand, table, bath, bed or other item proximate to a user. This may be as simple as comprising a substantially clear space on the outside surface (170) of the bottom (120) for gluing, welding, soldering or otherwise adhering a mounting mechanism, or locating a plurality of holes for accepting, but not limited to, screws, rivets, anchors or standoffs for attaching a mounting mechanism. In an alternative embodiment, the longitudinally elongated frame (100) of the Adjustable Extremity Suspension Apparatus (50) may be configured to accept a mounting mechanism on either side.

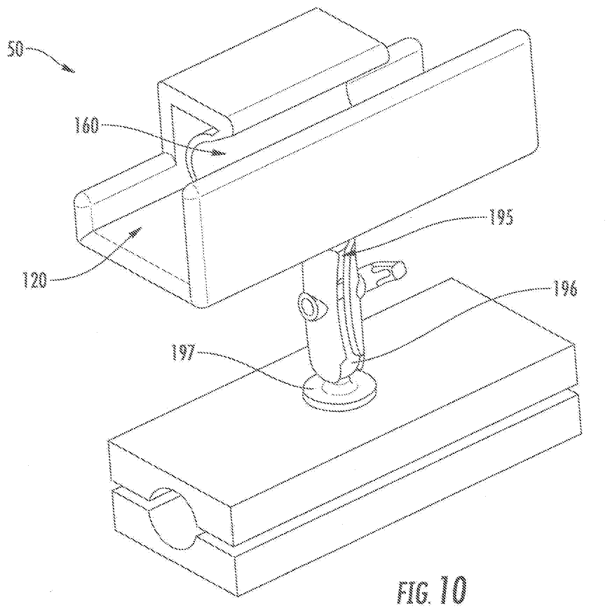

FIG. 10 shows an example of a mounting mechanism that would provide limited adjustment in six degrees of freedom, the mechanism comprising a mounting clamp (197) with provisions for capturing an arm rest bar (310) of a wheelchair (300) as shown on FIG. 8, and paired ball and socket joints (195) and (195). However, the invention is not limited to this mounting arrangement. If more latitude in all six degrees of freedom is desired in order to be able to provide translation in three perpendicular axes, combined with changes in orientation through rotation about the three perpendicular axes, then any mechanism providing a the combination of slides, pivots, extensions and rotations could be configured to attach to the longitudinally elongated frame (100) of the Adjustable Extremity Suspension Apparatus (50) and, in turn, mounted to a wheelchair (300), stand, table, bath, bed or other item proximate to a user.

In a preferred embodiment of the Adjustable Extremity Suspension Apparatus (50), the longitudinally elongated frame (100) comprises an extension (130) along the upper edge of one of the two longitudinally elongated vertical opposing sides (110) partially protruding over the elongated channel (160). This extension (130) provides three functions. First, it keeps the extremity receptacle (250) positioned within the elongated channel (160), but away from the rigid longitudinally elongated frame (100). Second, it provides a partial restriction on upward movement of the patient's extremity, which may be desired. Third, it can assist the patient in moving the Adjustable Extremity Suspension Apparatus (50) while adjusting its position,

In, another embodiment, one of the two longitudinally elongated vertical opposing sides (110) comprises an open notch (145) on each end in order to accommodate entry of the patient's forearm (400). In the preferred embodiment both of the open notches (145) and the extension (130) are on the same side of the longitudinally elongated vertical opposing sides (110).

In another embodiment the Adjustable Extremity Suspension Apparatus (50) comprises a flexible bladder or a cushion located on the bottom of the longitudinally elongated frame within the elongated channel, which works in combination with the elongated elastic sheet (200) to allow for a more customized support, especially with heavy extremities or even as a customizable patient seat. The bladder or cushion may be a flexible bladder for containing a fluid such as air or a gel, and may further be cellularly constructed to further control support. As a cushion it may be constructed of foam, polyester or down.

Referring to FIG. 5, there are cases where different extremities require support about an angle, a knee for example. Therefore, an alternate embodiment of the Adjustable Extremity Suspension Apparatus (50) comprises two longitudinally elongated frames (100) that are hingeably attached, end to end, along the bottom of each longitudinally elongated frame (100) thereby allowing the longitudinally elongated frames (100) to pivot to a desired angle. The hinge (185) can be integral to the longitudinally elongated frame (100), such as in a live in hinge, a strap or butt hinge, or it could comprise a piano-type or similar hinge. In order to preserve a desired angle for use, the longitudinally elongated frames (100) may comprise a series of positioning holes (180) through which a screw, rivet, pin or similar fastener may be inserted as a lock mechanism to fix the angle. In this embodiment, other than perhaps being sized differently, the elongated elastic sheet (200) remains the same.

Using the Adjustable Extremity Suspension Apparatus (50) to support a patient's extremity, such as a forearm (400) comprises locating the Adjustable Extremity Suspension Apparatus (50) to the desired position of the forearm (400), stretching the elongated elastic sheet (200) over the longitudinally elongated frame (100) such that the desired extremity support is achieved along the length of the Adjustable Extremity Suspension Apparatus (50), securing the paired adjustable length attachment mechanisms (220) around the longitudinally elongated frame (100) to hold the elongated elastic sheet (200) in place, and suspending the forearm (400) upon the elongated elastic sheet (200) within the elongated channel (160) in the longitudinally elongated frame (100).

Depending upon the type of mounting mechanism (197) used, or if hinged longitudinally elongated frames (100) are used, an additional step of tightening down or temporarily fixing the position setting may be required. Also, depending upon the support performance characteristics desired, an additional step of selecting the material layers (211) and (212) for the elongated elastic sheet (200) may be necessary.

It will readily be apparent to those skilled in the art that other applications are possible for the present invention, and while the embodiments described herein are illustrative of the invention, other modes of implementation are both within the spirit and scope of the invention.

What is claimed is:

1. An Adjustable Extremity Suspension Apparatus comprising:
a longitudinally elongated frame comprising:
two longitudinally elongated vertical opposing sides,
two opposing open ends,
an open top, and
a bottom,
wherein the two longitudinally elongated vertical opposing sides extend up from the bottom thus creating an elongated channel between the two longitudinally elongated vertical opposing sides and creating an exterior surface along the longitudinally elongated frame opposite the channel, and
a longitudinally elongated elastic sheet comprising a perimeter and a plurality of paired adjustable length attachment mechanisms disposed along the perimeter,
wherein the longitudinally elongated elastic sheet is shaped to drape over the open top and adjacent to the exterior surface of the elongated frame, and wherein the paired adjustable length attachment mechanisms attach to secure the elongated elastic sheet around the longitudinally elongated frame.

2. The Adjustable Extremity Suspension Apparatus of claim 1 wherein the bottom of the longitudinally elongated frame is configured to accept a mounting mechanism for securing the Adjustable Extremity Suspension Apparatus to a wheelchair, stand, table, bed or other item proximate to a user.

3. The Adjustable Extremity Suspension Apparatus of claim 1 wherein the plurality of paired adjustable attachment mechanisms comprises a plurality of paired hook-and-loop straps.

4. The Adjustable Extremity Suspension Apparatus of claim 1 wherein at least one of the two longitudinally elongated vertical opposing sides comprises an extension along its upper edge partially protruding over the elongated channel.

5. The Adjustable Extremity Suspension Apparatus of claim 1 wherein one of the two longitudinally elongated vertical opposing sides comprises an open notch on each end.

6. The Adjustable Extremity Suspension Apparatus of claim 1 wherein the perimeter of the longitudinally elongated elastic sheet comprises an elastic band.

7. The Adjustable Extremity Suspension Apparatus of claim 1 wherein the longitudinally elongated elastic sheet is shaped such that it forms an elongated cavity within the elongated channel of the longitudinally elongated frame.

8. The Adjustable Extremity Suspension Apparatus of claim 1 wherein the longitudinally elongated elastic sheet comprises a plurality of layers.

9. The Adjustable Extremity Suspension Apparatus of claim 8 wherein the plurality of layers comprises a mesh layer and a polyester layer.

10. The Adjustable Extremity Suspension Apparatus of claim 1 comprising a flexible bladder located on the bottom of the longitudinally elongated frame within the elongated channel.

11. The Adjustable Extremity Suspension Apparatus of claim 10 wherein the flexible bladder is filled with air.

12. The Adjustable Extremity Suspension Apparatus of claim 10 wherein the flexible bladder is filled with a liquid or gel.

13. An Adjustable Extremity Suspension Apparatus comprising:
two longitudinally elongated frames, each frame comprising:
two longitudinally elongated vertical opposing sides,
two opposing open ends,
an open top, and
a bottom,
wherein the two longitudinally elongated vertical opposing sides of each frame extend up from the bottoms of each frame thus creating respective elongated channels between the two longitudinally elongated vertical opposing sides and creating respective exterior surfaces along the longitudinally elongated frames opposite the channels, and
wherein the two longitudinally elongated frames are hingeably attached end to end along the bottom of each longitudinally elongated frame thereby allowing the elongated frames to pivot to a desired angle, and
a longitudinally elongated elastic sheet comprising a perimeter and a plurality of paired adjustable length attachment mechanisms disposed along the perimeter,
wherein the longitudinally elongated elastic sheet is shaped to drape over the open tops of each of the two hingeably attached longitudinally elongated frames and adjacent to the exterior surfaces of each of the two hingeably attached longitudinally elongated frames, and wherein the paired adjustable length attachment mechanisms are attached to secure the elongated elastic sheet around each of the hingeably attached longitudinally elongated frames.

14. The Adjustable Extremity Suspension Apparatus of claim 13 comprising a lock mechanism disposed on at least one of the longitudinally elongated frames to fix the desired angle of the two longitudinally elongated frames.

15. A method for adjustably suspending an extremity using the Adjustable Extremity Suspension Apparatus of claim 2 comprising: positioning the apparatus, stretching the elongated sheet over the longitudinally elongated frame such that the desired extremity support pressure is achieved along the length of the apparatus, securing the paired adjustable length attachment mechanisms around the longitudinally elongated frame to hold the elongated sheet in place, and suspending the extremity upon the elongated sheet within the elongated channel in the longitudinally elongated frame.

16. The method for adjustably suspending en extremity using Adjustable Extremity Suspension Apparatus of claim 15 further comprising: selecting a longitudinally elongated elastic sheet that accommodates desired extremity suspension performance characteristics.
